(19) United States
(12) Patent Application Publication
(10) Pub. No.: US 2026/0064498 A1
(43) Pub. Date: Mar. 5, 2026

(54) SYSTEMS AND METHODS FOR CROSS-DEVICE CLIPBOARD SYNCHRONIZATION

(71) Applicant: CELLIGENCE INTERNATIONAL LLC, Guaynabo, PR (US)

(72) Inventors: Pavan AGARWAL, DORADO, PR (US); Gabriel Albors SANCHEZ, SAN JUAN, PR (US); Jonathan Ortiz RIVERA, SAN JUAN, PR (US)

(73) Assignee: CELLIGENCE INTERNATIONAL LLC, Guaynabo, PR (US)

(21) Appl. No.: 19/333,071

(22) Filed: Sep. 18, 2025

Related U.S. Application Data
(63) Continuation-in-part of application No. 19/229,943, filed on Jun. 5, 2025.
Application No. 19/229,943 is a continuation-in-part of application No. 18/135,703, filed on Apr. 17, 2023, now Pat. No. 12,393,433.
(60) Provisional application No. 63/332,205, filed on Apr. 18, 2022.

(51) Int. Cl. G06F 9/54

(52) U.S. Cl. CPC G06F 9/543; G06F 9/542

(57) ABSTRACT

Systems and methods are disclosed for cross-device clipboard synchronization. A first client device detects a copy event, encrypts the copied content, and transmits it to a conversational application server. The server classifies the copied content, stores it as an entry in an account-scoped memory referred to as Angel Memory, and signals availability to a second client device. The second device retrieves and decrypts the entry for insertion into an active input field. Angel Memory persists multiple entries with metadata such as timestamp, originating device, and content type, enabling context-aware retrieval across devices. In some embodiments, code snippets are preserved with formatting fidelity, one-time passcodes are enforced with expiration and single-use policies, and secured entries require authentication before release. Policy modules may apply governance decisions such as block, mask, retain, or expire. The disclosed system improves workflow efficiency, security, and compliance in cross-device content management.

### RELATED APPLICATIONS

This application a continuation-in-part of U.S. patent application Ser. No. 19/229,943, filed on Jun. 5, 2025, which is a continuation-in-part of U.S. patent application Ser. No. 18/135,703, filed on Apr. 17, 2023, which claims the benefit of U.S. Provisional Application No. 63/332,205 filed on Apr. 18, 2022, the contents of which are incorporated herein by reference in its entirety.

### FIELD OF INVENTION

The present disclosure relates to systems and methods for digital content management, and more particularly, to facilitating seamless code and text transfer between mobile and desktop platforms using an AI-assisted synchronization framework.

### BACKGROUND

Copying and pasting content between devices often requires manual effort, such as emailing oneself or using third-party messaging apps. This creates inefficiencies, introduces risk of human error, and disrupts user workflow. Existing clipboard sync tools are limited in scope, lacking AI-based recognition, context-awareness, and secure account-based synchronization. There is a need for an intelligent, seamless solution that enables cross-device content transfer within a trusted framework.

### SUMMARY

The present disclosure provides systems and methods for facilitating secure and seamless cross-device clipboard synchronization. The system enables a user to copy content on one device and paste it on another without manual transfer, while maintaining formatting, context, and security.

In operation, a clipboard capture agent and uploader on a first client device detect a copy event and encrypt the copied content for transmission to a conversational application server. The server classifies the content to determine whether it represents free text, a code snippet, a one-time passcode, or other structured data. The server then stores the content in a centralized account-based memory referred to as Angel Memory. Angel Memory maintains multiple synchronized entries along with metadata including timestamp, originating device, and policy attributes.

A second client device receives notification of availability and, based on context such as an active editor window or login field, may request retrieval of a selected entry. The server decrypts and releases the entry for insertion into the active input field. Code snippets are preserved with formatting fidelity, while OTPs are handled with expiration and single-use enforcement. Secured entries require user authentication, such as password or biometric input, before decryption.

Policy and governance modules may apply rules including block, mask, retain, or expire prior to storage of an entry. In some embodiments, masked entries obscure sensitive portions of a payload, blocked entries are discarded with optional user notification, and retention timers enforce time-to-live restrictions.

By combining multi-entry persistence, classification-aware handling, secured workflows, and centralized governance, the disclosed system provides technical advantages over conventional clipboard synchronization approaches, improving usability, security, and compliance across mobile, desktop, and tablet environments.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIGS. 1A-1E are block diagrams illustrating an exemplary system architecture for cross-device content synchronization, including a conversational application server, client devices, and supporting modules, according to an implementation of the disclosure.

FIGS. 2A-2B are flow diagrams illustrating exemplary workflows for transferring a code snippet (FIG. 2A) and a one-time passcode (FIG. 2B) between a mobile device and a desktop device via a conversational application server, according to an implementation of the disclosure.

FIGS. 3A-3D are user interface diagrams illustrating mobile and desktop interactions for initiating transfer or secured copy operations on a mobile device and retrieving the synchronized content on a desktop device, according to an implementation of the disclosure.

FIG. 4 is a user interface diagram illustrating an Angel Memory view displaying synchronized entries available for cross-device retrieval, according to an implementation of the disclosure.

FIG. 5 is a low diagram illustrating a secured paste workflow requiring password or biometric authentication prior to decryption and insertion of a secured entry, according to an implementation of the disclosure.

FIG. 6 is a block diagram illustrating multi-device synchronization of Angel Memory entries across mobile, desktop, and tablet clients, according to an implementation of the disclosure.

FIG. 7 is a block diagram illustrating policy and governance enforcement for clipboard synchronization, including block, mask, retention, and expiration decisions prior to storage of entries in Angel Memory, according to an implementation of the disclosure.

FIG. 8 illustrates an example computing system that may be used in implementing various features of embodiments of the disclosed technology.

Described herein are systems and methods for seamless cross-device content transfer and synchronization within a conversational framework. During a session, the system enables a user to copy content on a first device, such as a mobile phone, and retrieve or paste the same content on a second device, such as a desktop or tablet, without requiring manual transmission. A clipboard capture agent and uploader encrypt the copied payload and transmit it to a conversational application server, where classification and policy modules determine content type (e.g., source code, links, or one-time passcodes) and enforce retention, masking, or expiration rules. Entries are persisted in Angel Memory, a centralized account-based data store, as either transfer entries or secured entries with heightened protections. Notifications are propagated to the user's other devices, where availability detectors monitor application context (e.g., IDE windows, login fields) to surface paste options through a paste facilitator. Secured entries require password or biometric authentication before decryption and insertion. This architecture improves usability and workflow efficiency by eliminating error-prone manual transfers, while providing technical advantages such as consistent formatting preservation for code, automated OTP handling with single-use enforcement, and centralized governance over synchronization policies across all devices. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

In a present embodiment, a cross-device clipboard synchronization system enables a user to copy content on one device and seamlessly paste it on another without manual transfer. When a user copies text, code, or a one-time passcode (OTP) on a mobile device, the system detects the copy event, classifies the content, and securely synchronizes it through a server-based framework. Copied payloads are persisted in a centralized account-scoped data store referred to herein as Angel Memory, which maintains synchronized entries along with associated metadata such as content type, originating device, and retention policy. Upon switching to a desktop environment, the system surfaces the synchronized clipboard item as an available paste option, complete with contextual indicators such as content type or device origin. This provides a fluid and intelligent mechanism for moving content across devices while maintaining formatting, context, and security.

As used herein, the term “Angel Memory” refers to a centralized, account-based data store maintained by the conversational application server. Angel Memory persists synchronized clipboard entries originating from one or more user devices, including transfer entries for general content and secured entries for sensitive data. Each entry may be associated with metadata such as a timestamp, originating device identifier, content-type label (e.g., text, code snippet, OTP), and policy attributes (e.g., retention window, masking requirements, or authentication flags). Angel Memory thereby functions as a unified memory layer across devices, ensuring that copied content is accessible for context-appropriate paste operations while enforcing governance, security, and expiration rules.

### Conventional System Limitations

Conventional cross-device clipboard solutions are generally limited to short-range device pairing mechanisms and single-entry memory models. For example, platform-native universal clipboards typically transmit only the most recent copy event between two devices over Bluetooth, Wi-Fi Direct, or similar channels. These systems lack persistence beyond a brief window, and once overwritten by a new copy event, prior content becomes irretrievable. They further operate in a context-blind manner, surfacing copied content uniformly across applications without regard to whether the receiving context is a code editor, login field, or messaging interface. Security features are minimal: copied one-time passcodes may be exposed without expiration or single-use enforcement, and sensitive content is transferred without additional authentication or governance. Additionally, such systems provide little transparency or auditability, offering no mechanism for retention rules, masking, or compliance logging. These limitations introduce friction, risk, and inefficiency when users attempt to manage diverse types of content across multiple devices.

### Technical Improvements of the Present Disclosure

Conventional clipboard synchronization systems, such as platform-native universal clipboards, typically replicate only a single most-recent copy event between paired devices using short-range communication (e.g., Bluetooth, Wi-Fi Direct). These approaches lack persistent memory, provide little to no classification of content, and offer limited safeguards for sensitive data such as one-time passcodes. As a result, users are constrained to transient, context-blind transfer with no governance or auditability.

In contrast, the present disclosure introduces a server-based synchronization framework centered on Angel Memory, an account-scoped, multi-entry data store. Angel Memory persists multiple synchronized entries, each tagged with metadata including originating device, timestamp, content type, and applicable policy. The system integrates classification modules that distinguish code snippets, URLs, free-text, and OTPs, applying specialized handling such as formatting preservation for code or single-use enforcement for OTPs. For secured entries, the system enforces an additional authentication layer at paste time, requiring the user to re-enter a password or provide biometric credentials before decryption and release.

These architectural improvements provide several technical advantages: (i) multi-entry recall across devices, allowing a user to select from a history of prior copies rather than being limited to the last item; (ii) differentiated handling of content types with context-aware paste (e.g., IDE detection, login field detection); (iii) policy-driven governance that supports blocking, masking, retention limits, and audit logging for compliance-sensitive environments; and (iv) account-level portability across multiple device types, enabling continuity between mobile, desktop, and tablet contexts without dependency on short-range communication protocols. The result is a more secure, robust, and flexible cross-device clipboard synchronization system that extends beyond conventional implementations.

The following figures provide a high-level overview of the system architecture, illustrating key modules and data flows between user devices and the server.

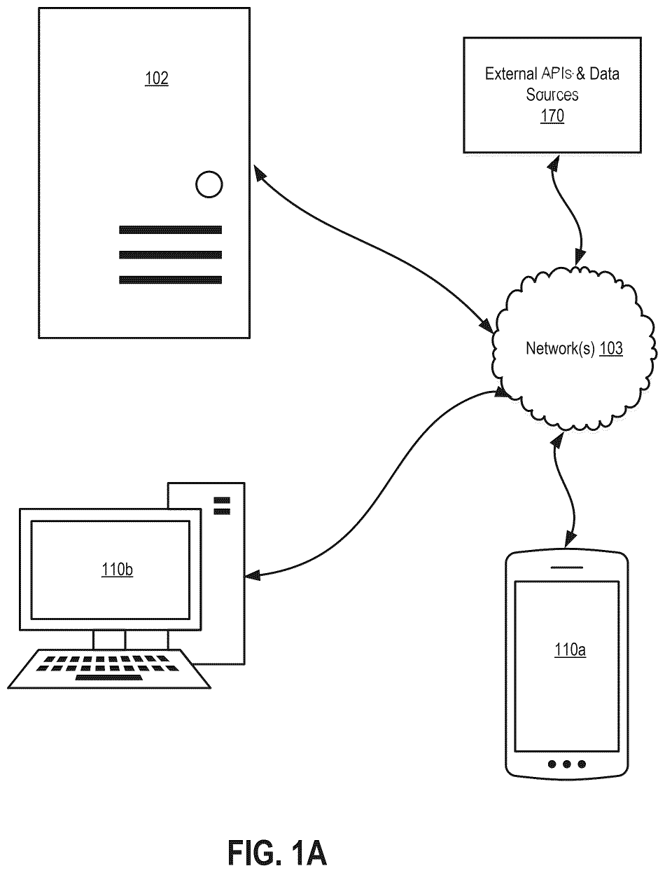

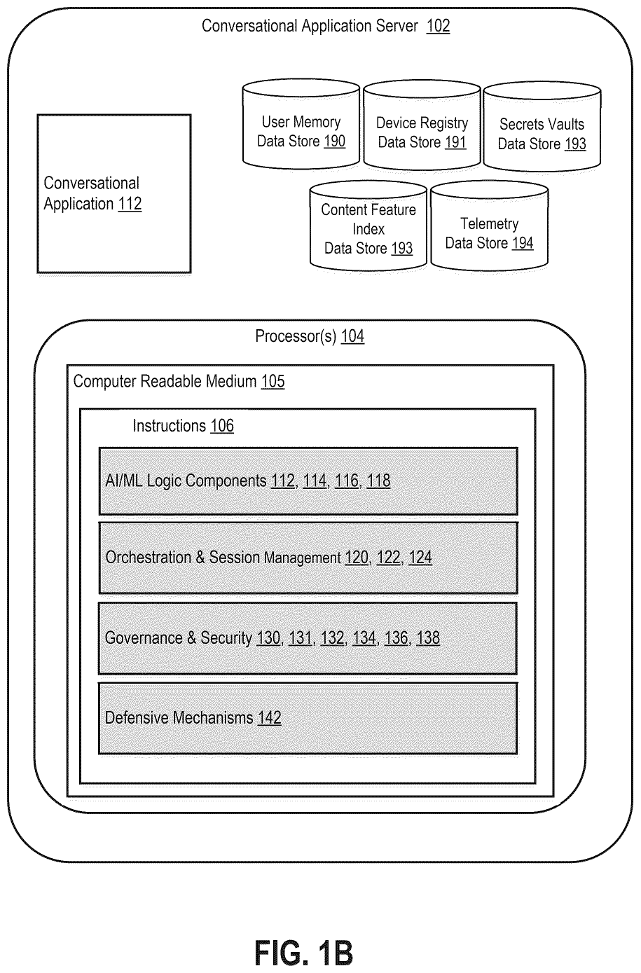

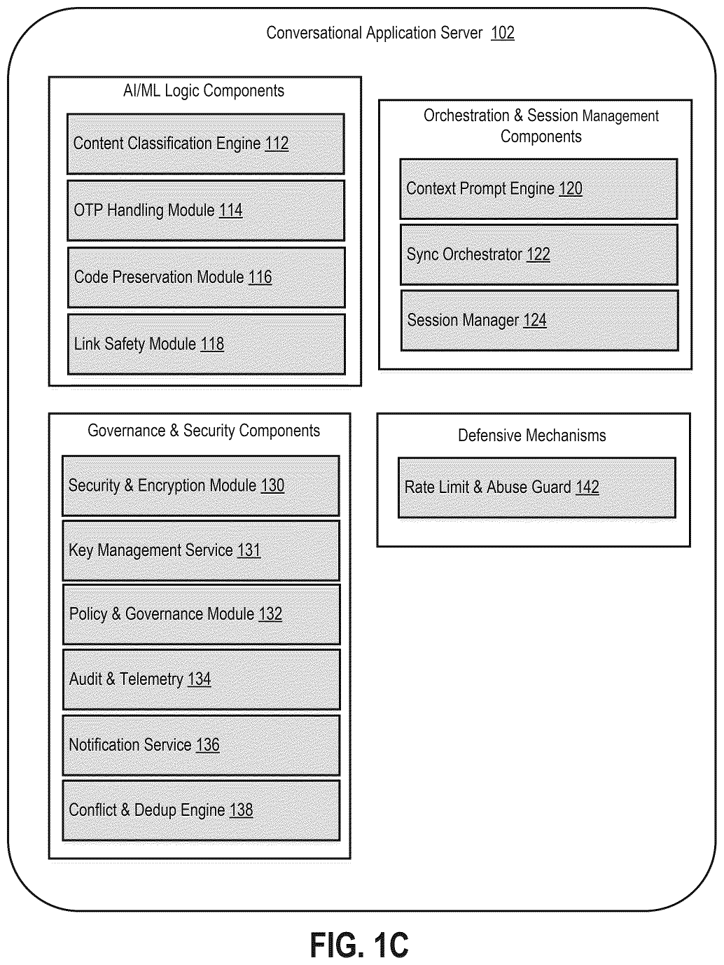

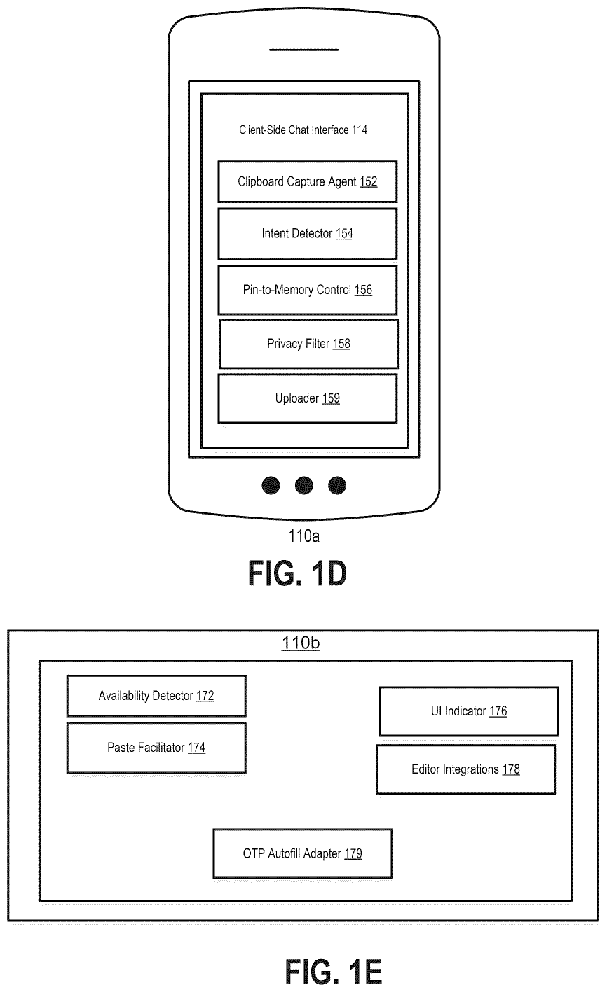

FIG. 1A is a block diagram illustrating an exemplary system environment for cross-device clipboard synchronization. The environment includes a conversational application server 102 communicatively coupled to one or more networks 103. A mobile device 110a and a desktop device 110b are operatively connected to the server 102 via the network(s) 103 which may include public networks (e.g., the Internet), private enterprise networks, or hybrid architectures. External APIs and data sources 170, which provide supplemental services such as URL reputation checks, third-party content validation, or integration with enterprise policy frameworks. External APIs and data sources 170 may also be coupled to the server 102 to provide third-party content validation, enrichment, or policy services.

The conversational application server 102 provides the central orchestration layer for clipboard synchronization. Architecturally, the server comprises one or more processors 104 coupled to memory storing executable instructions 106. The server is implemented as a modular, service-oriented platform in which functional engines (e.g., content classification engine 112, sync orchestrator 122, security and encryption module 130 illustrated in FIGS. 1B, 1C) operate as independently scalable services. The server 102 may be deployed as a distributed cluster or virtualized cloud instance, allowing horizontal scaling of specific modules such as OTP handling or conflict deduplication. The server maintains persistent connections with multiple client devices and leverages the user memory store 190, device registry 191, and other datastores to enforce identity, trust, and governance policies during cross-device synchronization.

The mobile device 110a is a client endpoint configured to detect, classify, and upload clipboard events. The device may be a smartphone, tablet, or wearable computing platform executing a native client application (e.g., AngelAI) or a lightweight SDK. Architecturally, the mobile device 110a comprises an operating system clipboard service accessed by a clipboard capture agent 152, a classification and privacy pipeline (intent detector 154, privacy filter 158), and a secure transmission component (uploader 159), as illustrated in FIG. 1D. The device may also incorporate trusted execution hardware (e.g., secure enclave) for on-device encryption key storage and may apply per-application policies, such as blocking transfer from banking applications. The mobile device is optimized for low-latency detection of copy events and efficient encrypted upload to the server 102 via network 103.

The desktop device 110b is a client endpoint configured to retrieve, present, and paste synchronized clipboard items. The device may be a laptop, desktop workstation, or thin client running a desktop client application or browser extension. Architecturally, the desktop device 110b includes modules for detecting available paste contexts (availability detector 172), retrieving synchronized content (paste facilitator 174), and presenting contextual indicators (UI indicator 176), as illustrated in FIG. 1E. Additional modules such as editor integrations 178 preserve formatting fidelity when inserting code snippets into integrated development environments (IDEs), while an OTP autofill adapter 179 ensures one-time codes are injected securely into verified authentication fields. The desktop device 110b maintains a secure session with the server 102, periodically polling or receiving push notifications from the notification service 136 to surface ready-to-paste items to the user interface.

Together, the conversational application server 102, the mobile device 110a, and the desktop device 110b form an integrated architecture for cross-device clipboard synchronization. The mobile device 110a operates as the capture endpoint, detecting copy events and securely uploading encrypted payloads. The conversational application server 102 functions as the orchestration hub, classifying content, applying policy controls, and maintaining synchronized user memory across trusted devices. The desktop device 110b operates as the paste endpoint, receiving availability signals from the server 102 and surfacing context-aware prompts for content insertion. This triad architecture ensures that copied content flows seamlessly from capture to synchronization to paste, with each layer contributing specialized functions—lightweight detection on the mobile side, robust orchestration at the server, and context-sensitive presentation on the desktop side. The result is a technically improved framework that reduces manual transfer steps, preserves content fidelity, and embeds security controls throughout the synchronization pipeline.

As further illustrated in FIG. 1A, the system may integrate with external APIs and data sources 170 coupled to the conversational application server 102 via the network(s) 103. The external APIs and data sources 170 may include, but are not limited to, third-party security services, content reputation feeds, enterprise policy engines, cloud storage providers, or authentication services. In one embodiment, the link safety module 118 queries an external reputation service via the external APIs 170 to validate a URL prior to allowing paste on the desktop device 110b. In another embodiment, the OTP handling module 114 verifies an authentication code against an enterprise identity provider accessible through the external APIs 170.

The external APIs and data sources 170 may also be used to enrich content metadata or extend governance controls. For example, when the content classification engine 112 identifies that copied content includes code in a particular programming language, it may call an external syntax-checking service to generate format hints, which are then preserved by the code preservation module 116. Similarly, the policy and governance module 132 may consult an enterprise compliance API to determine whether a clipboard transfer is permitted under a specific tenant policy before synchronizing the item.

By incorporating external APIs and data sources 170, the system allows modular extension of capabilities without requiring all validation, enrichment, or policy logic to reside within the server 102 itself. This provides flexibility for enterprise customers to integrate existing infrastructure, enhances the adaptability of the synchronization framework, and ensures that evolving security and compliance requirements can be satisfied with minimal changes to client-side modules.

FIG. 1B is a schematic diagram illustrating internal components of the conversational application server 102. The server includes one or more processors 104 configured to execute computer-readable instructions 106 stored on a non-transitory medium. The instructions 106 implement a conversational application 112 and associated functional modules. As shown, the server 102 is operatively connected to multiple datastores, including a user memory data store 190 for encrypted clipboard entries and associated metadata; a device registry data store 191 for managing trusted devices associated with user accounts; a secrets vault 192 for cryptographic keys and policy material; a content feature index 193 for non-sensitive derived features (e.g., content type or hash values); and a telemetry data store 194 for metrics, logging, and compliance reporting. The functional modules are organized into groups including AI/ML logic components 112, 114, 116, 118; orchestration and session management components 120, 122, 124; governance and security components 130, 131, 132, 134, 136, 138; and defensive mechanisms 142.

Hardware processor 104 may be one or more central processing units (CPUs), semiconductor-based microprocessors, and/or other hardware devices suitable for retrieval and execution of instructions stored in computer readable medium 105. Processor 104 may fetch, decode, and execute instructions 106, to control processes or operations for automatically categorizing tasks and assigning color. As an alternative or in addition to retrieving and executing instructions, hardware processor 104 may include one or more electronic circuits that include electronic components for performing the functionality of one or more instructions, such as a field programmable gate array (FPGA), application specific integrated circuit (ASIC), or other electronic circuits.

A computer readable storage medium, such as machine-readable storage medium 105 may be any electronic, magnetic, optical, or other physical storage device that contains or stores executable instructions. Thus, computer readable storage medium 105 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 105 may be a non-transitory storage medium, where the term “non-transitory” does not encompass transitory propagating signals. As described in detail below, machine-readable storage medium 105 may be encoded with executable instructions, for example, instructions 106.

FIG. 1C is a block diagram further illustrating individual modules of the conversational application server 102 organized by category. The AI/ML logic components include a content classification engine 112, which analyzes incoming clipboard content to determine whether the content is code, a URL, plain text, or a one-time passcode (OTP). An OTP handling module 114 applies one-time-use semantics and expiration windows for sensitive authentication codes. A code preservation module 116 maintains original formatting of source code snippets, ensuring indentation and whitespace integrity are preserved across devices. A link safety module 118 optionally validates URLs against internal or external reputation services to prevent unsafe pasting.

The orchestration and session management components include a context prompt engine 120 that determines whether a paste suggestion should be surfaced to the user, a sync orchestrator 122 that manages delivery of clipboard content between authenticated devices, and a session manager 124 that maintains login state, device tokens, and trust posture.

In some embodiments, the system provides differentiated workflows for standard and secured clipboard synchronization. The security and encryption module 130, in conjunction with the policy and governance module 132, is configured to enforce a “copy with key” option. When the mobile device 110a designates content as secured—either through user selection (e.g., “Copy S”) or automatic classification by the intent detector 154—the payload is encrypted with an additional key layer associated with the user's account credentials. During retrieval on the desktop device 110b, the paste facilitator 174 communicates with the server 102, which prompts the user for authentication, such as re-entry of the account password, biometric verification, or multifactor credentials. Only after successful validation does the server 102 instruct the security and encryption module 130 to decrypt and release the payload. This architectural integration ensures that sensitive data is not only encrypted at rest and in transit but also gated by real-time user verification prior to paste, thereby mitigating risks of unauthorized access on shared or compromised endpoints.

The governance and security components include a security and encryption module 130 that applies end-to-end encryption to clipboard payloads, a key management service 131 that rotates and manages device-specific keys, a policy and governance module 132 that enforces tenant and user policies (such as application allow/deny lists or masking rules), an audit and telemetry module 134 for immutable logging of copy and paste events, a notification service 136 for lightweight “ready-to-paste” prompts, and a conflict and deduplication engine 138 for managing multiple concurrent clipboard events. Defensive mechanisms include a rate limit and abuse guard 142 that throttles anomalous activity and prevents abuse of OTP synchronization.

FIG. 1D is a block diagram illustrating client-side modules of the mobile device 110a. The mobile device 110a implements a client-side chat interface 114 with modules for detecting and preparing clipboard content. A clipboard capture agent 152 monitors operating system clipboard events and normalizes copied content. An intent detector 154 classifies the copied content into categories such as code, OTP, or plain text. A pin-to-memory control 156 allows the user to persist specific clipboard items to their synchronized memory, overriding default expiration windows. A privacy filter 158 redacts sensitive elements (e.g., credit card numbers) based on configured rules. An uploader 159 encrypts the clipboard payload and transmits it, along with contextual metadata (timestamp, application origin, locale, and hash), to the server 102.

FIG. 1E is a block diagram illustrating client-side modules of the desktop device 110b. The desktop device 110b includes modules for receiving, presenting, and pasting synchronized content. An availability detector 172 monitors the state of active input fields or editors to determine when pasting is appropriate. A paste facilitator 174 retrieves synchronized content from the server 102 and inserts it into the active application upon user command (e.g., a keyboard shortcut). A UI indicator 176 provides visual cues such as a mobile icon or content type tag, helping the user recognize the source of the content. Editor integrations 178 preserve formatting when pasting code or structured text. An OTP autofill adapter 179 specifically handles one-time passcodes, ensuring they are only injected into verified authentication fields and automatically expired after a single use.

Together, the components of FIGS. 1A-1E provide a secure and seamless framework for cross-device clipboard synchronization. The mobile device 110a captures and classifies clipboard events, applies privacy rules, and uploads encrypted content to the conversational application server 102. The server 102 processes the content, enforces policies, and makes the content available to authenticated devices. The desktop device 110b retrieves the content, presents contextual prompts, and pastes the content into appropriate contexts. The architecture allows users to copy text, code, or authentication data on one device and seamlessly paste it on another, thereby reducing friction, improving productivity, and maintaining compliance with security and governance requirements.

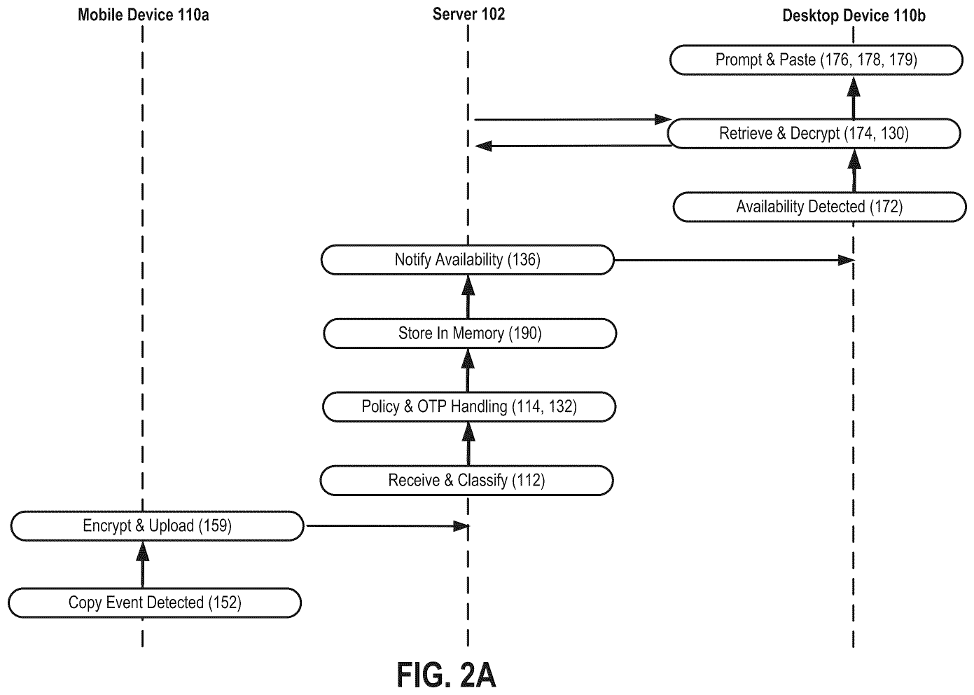

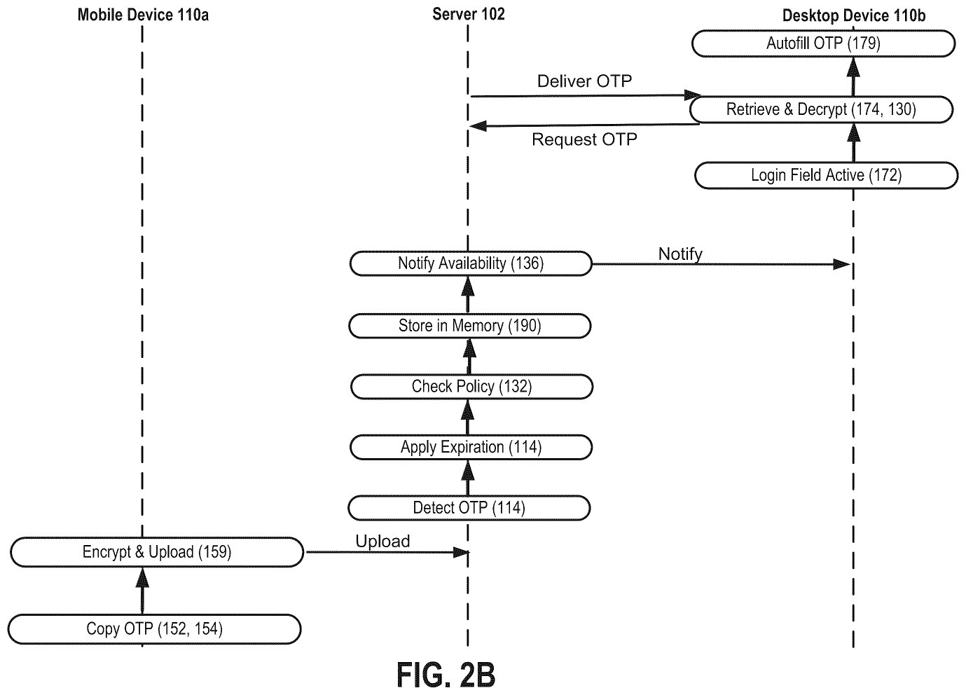

FIG. 2A is a flow diagram illustrating an exemplary workflow for transferring a code snippet between a mobile device 110a and a desktop device 110b via the conversational application server 102. In operation, a user copies a block of source code on the mobile device 110a, where the clipboard capture agent 152 detects the copy event and normalizes the payload for transmission. The uploader 159 encrypts the snippet along with contextual metadata such as timestamp, originating application, and locale, and transmits the encrypted payload to the server 102. At the server, the content classification engine 112 analyzes the payload, determines that the content corresponds to a code snippet, and applies a corresponding content-type label. The code preservation module 116 ensures that indentation, whitespace, and encoding are retained across platforms. The snippet is stored as an entry 404 within Angel Memory 402 in the user memory store 190, indexed for efficient retrieval, and the notification service 136 issues a signal to the desktop device 110b indicating that a new Angel Memory entry is available.

On the desktop side, the availability detector 172 monitors application context and recognizes that an integrated development environment (IDE) or other code editor is active, making the retrieved content contextually relevant. The paste facilitator 174 initiates a request to the server 102 and, upon receiving the encrypted payload, coordinates with the security and encryption module 130 to decrypt the snippet from the selected Angel Memory entry 404. The editor integrations 178 ensure syntax highlighting, indentation, and line formatting are preserved in the target editor, while the UI indicator 176 surfaces a visual badge identifying both the content type (“code snippet”) and the originating device (mobile 110a). Once the snippet is inserted into the editor, the audit and telemetry module 134 generates a log entry capturing the copy, synchronization, and paste sequence for compliance and diagnostic tracking.

FIG. 2B is a flow diagram illustrating an exemplary workflow for transferring a one-time passcode (OTP) between a mobile device 110a and a desktop device 110b via the conversational application server 102. In operation, a user receives an OTP (e.g., via SMS, push notification, or application alert) on the mobile device 110a and copies it into the system clipboard. The clipboard capture agent 152 detects the copy event, and the intent detector 154 analyzes the payload to identify its structure as an OTP, such as a six-digit numeric sequence. The uploader 159 encrypts the OTP along with contextual metadata and transmits the encrypted payload to the server 102. At the server, the OTP handling module 114 applies expiration windows, enforces single-use semantics, and flags the payload as sensitive. The policy and governance module 132 verifies compliance with tenant-specific rules, such as restricting OTP synchronization for certain applications or requiring VPN context. If permitted, the OTP is stored as a short-term entry 404 in Angel Memory 402 in the user memory store 190, and the notification service 136 transmits an availability signal to the desktop device 110b.

On the desktop side, the availability detector 172 identifies that the current input focus corresponds to an authentication field on a login page. The paste facilitator 174 then issues a request to the server 102 and, upon receiving the encrypted OTP, coordinates with the security and encryption module 130 to decrypt the selected Angel Memory entry 404. The OTP autofill adapter 179 inserts the passcode directly into the authentication field, eliminating the need for manual typing. Once consumed, the entry 404 in Angel Memory 402 is immediately marked as expired by the server 102 to prevent replay or reuse, while the audit and telemetry module 134 generates a compliance log of the copy, synchronization, and paste sequence.

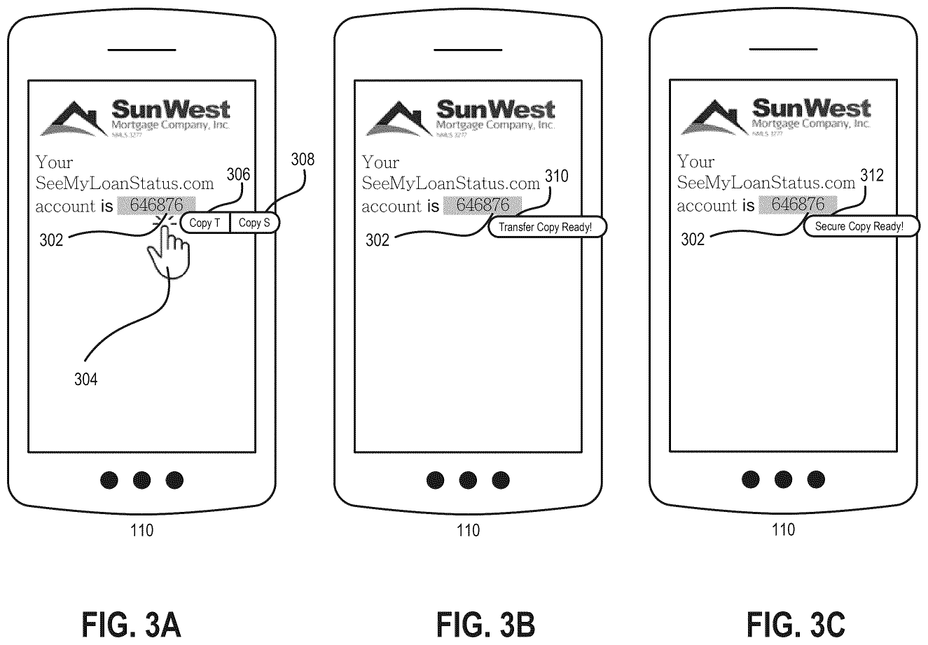

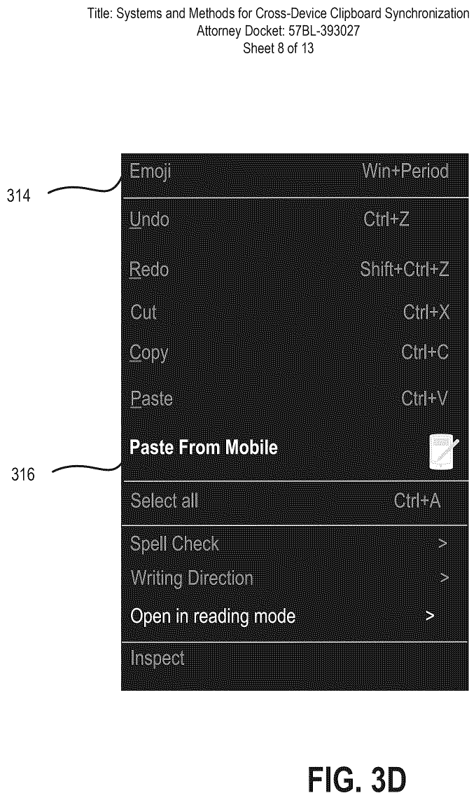

FIG. 3A illustrates an exemplary interface on a mobile device 110 in which a user taps and holds a text string or numerical sequence 302 (e.g., a one-time passcode) displayed in an application window 304. The long-press gesture invokes a contextual options menu 306. In the illustrated embodiment, the menu provides two selectable options: “Copy T” representing a transfer copy and “Copy S” representing a secured copy. The user may select either option depending on whether the copied content is intended for immediate synchronization across devices or protected storage within secured memory.

FIG. 3B illustrates the interface following selection of the “Copy T” option. The copied content 310 is highlighted, and a notification element 308 is displayed adjacent to the selection, indicating “Transfer Copy Ready.” This notification confirms that the content has been successfully captured, encrypted, and prepared for synchronization to the user's account on the conversational application server 102, where it is stored as a transfer entry 404 in Angel Memory 402 for subsequent retrieval on another device.

FIG. 3C illustrates the interface following selection of the “Copy S” option. The copied content 312 is highlighted, and a notification element indicates “Secure Copy Ready.” In this embodiment, the secure copy workflow applies additional protections, such as stricter encryption, restricted retention policies, or masking of sensitive digits, before synchronization. The secured payload is stored as a protected entry 416 within Angel Memory 402, ensuring it can only be released under heightened conditions. The user is thus assured that the copied content is being managed in accordance with enhanced security requirements.

FIG. 3D illustrates an exemplary interface on a desktop device 110b. A user initiates a contextual menu 314, for example by right-clicking within an input field, to display available paste options. In addition to conventional commands such as Cut, Copy, and Paste, the contextual menu includes a “Paste from Mobile” option 316. Upon selection of this option, the desktop device 110b communicates with the conversational application server 102 to retrieve the synchronized content previously stored in Angel Memory 402. Depending on whether the entry corresponds to a transfer entry 404 or a secured entry 416, the paste facilitator 174 and associated modules decrypt and insert the payload into the active input field, completing the cross-device transfer initiated in FIGS. 3A-3C.

The secured workflow described in connection with FIGS. 3A-3D integrates directly with the backend modules of the conversational application server 102. When a user selects the “Copy S” or “copy with key” option, the payload is tagged by the uploader 159 with a security flag and processed by the policy and governance module 132. The server applies heightened protections, including restricted retention rules and secondary encryption layers managed by the key management service 131. When the user later selects “Paste from Mobile” on the desktop device 110b, the paste facilitator 174 requests the secured payload, but the conversational application server 102 requires successful user authentication before the security and encryption module 130 decrypts the data. If authentication fails, the secured payload remains inaccessible. This cooperative operation between the mobile-side interface, Angel Memory 402, and the governance and encryption subsystems ensures that confidential data is protected end-to-end, while still enabling seamless cross-device workflows.

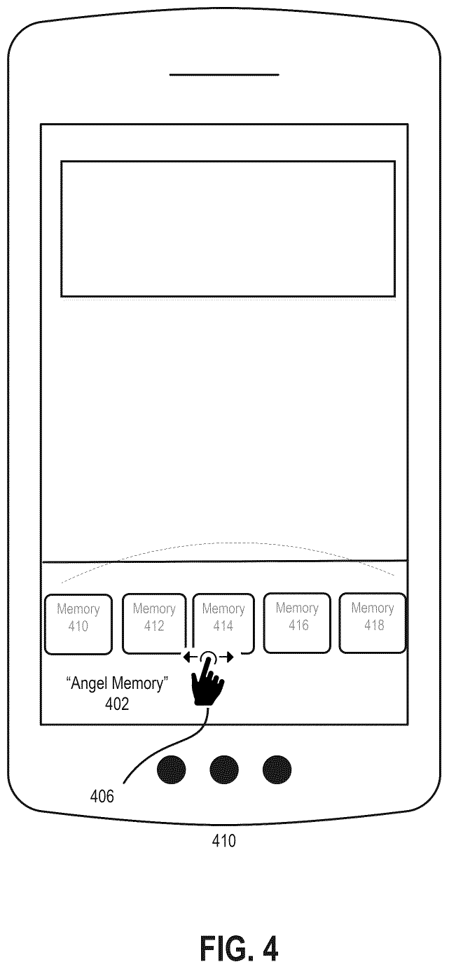

FIG. 4 illustrates an exemplary “Angel Memory” interface 402 in which synchronized clipboard items are presented in a scrollable list 406 on a client device 110. In the illustrated embodiment, each time a user copies content on a mobile device 110a or a desktop device 110b, the content is encrypted, transmitted to the conversational application server 102, and stored in the user memory store 190. The synchronized items appear as entries 404 in an ordered history view referred to as Angel Memory 402. A user may scroll through the list 406 to review prior copies, each entry including contextual indicators such as the originating device icon 408, timestamp 410, and content classification label 412. Certain entries correspond to standard transfer copies 404, while others correspond to secured entries 416, which are visually distinguished (e.g., by a lock icon) and require user authentication before release.

When the user highlights or selects a particular entry 404 or 416 from Angel Memory 402, the paste facilitator 174 retrieves the encrypted payload from the server 102, invokes the security and encryption module 130 for decryption, and inserts the content into the active input field 414 on the desktop or mobile interface. By maintaining both transfer and secured entries in a scrollable, contextual record, Angel Memory 402 provides a technical advantage over conventional clipboard synchronization mechanisms by enabling multi-item recall, differentiated security workflows, and selective cross-device pasting of sensitive data.

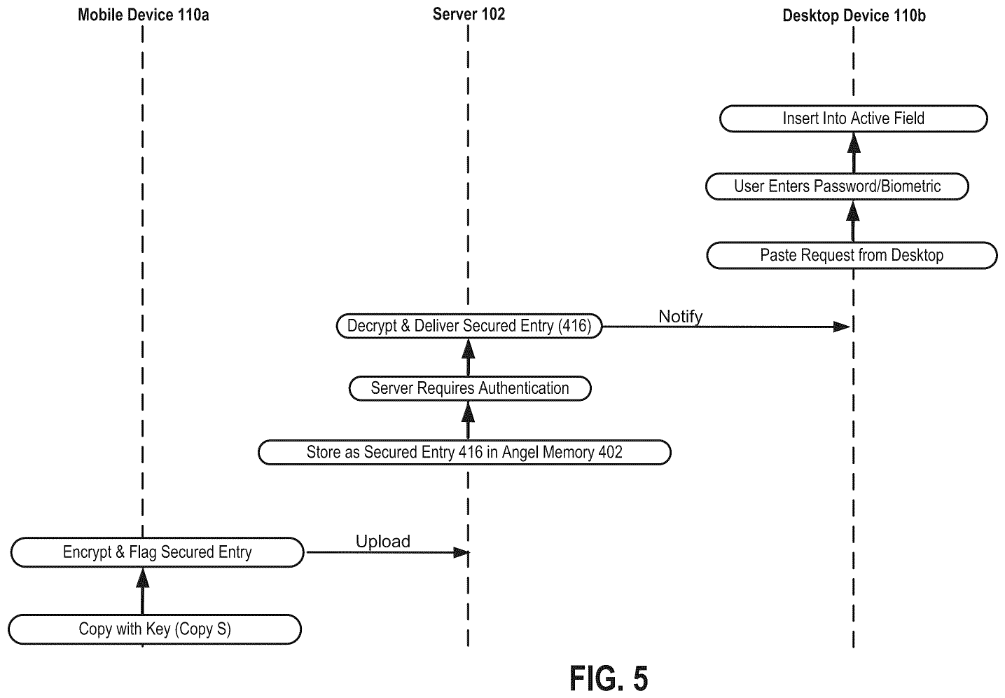

FIG. 5 is a flow diagram illustrating an exemplary workflow for performing a secured cross-device paste operation with authentication enforcement. In the illustrated embodiment, a user on the mobile device 110a invokes the “Copy with Key” option (Copy S), designating the selected payload as sensitive. The clipboard capture agent 152 detects the copy event, and the uploader 159 encrypts the payload, applies a secure flag, and packages contextual metadata including originating application, timestamp, and device identifier. The encrypted payload is transmitted to the conversational application server 102, where it is stored as a secured entry 416 within Angel Memory 402. The server associates the entry with stricter retention policies and enhanced protections, such as secondary encryption layers managed by the key management service 131 and governance checks applied by the policy module 132.

Upon storage, the notification service 136 transmits a signal to the desktop device 110b indicating that a secured entry is available. When the user initiates a paste request from the desktop client, the paste facilitator 174 issues a retrieval request to the server 102. Before the secured entry 416 is decrypted, the server requires explicit user authentication, such as entry of an Angel AI password, token, or biometric verification. If authentication succeeds, the security and encryption module 130 decrypts the payload, and the server delivers the secured entry 416 to the desktop client. The decrypted content is then inserted into the active input field of the desktop device 110b, completing the secured cross-device paste. If authentication fails, the secured entry 416 remains inaccessible, and the attempt is logged by the audit and telemetry module 134 for compliance and diagnostic tracking.

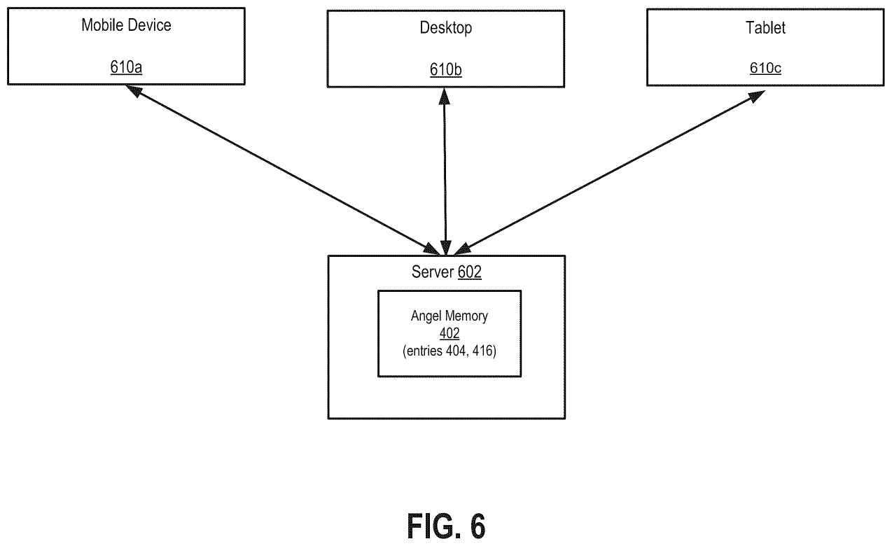

FIG. 6 is a block diagram illustrating an exemplary multi-device synchronization architecture for Angel Memory 402. In the illustrated embodiment, a mobile device 610a, a desktop device 610b, and a tablet device 610c are each communicatively coupled to a conversational application server 602 via one or more networks 103. The server 602 maintains Angel Memory 402, which stores synchronized entries 404 and secured entries 416 originating from user activity across devices. When a user copies content on any of the connected devices, the clipboard capture agent 152 and uploader 159 transmit the payload to the server 602, where the content classification engine 112, OTP handling module 114, or other AI/ML components process and tag the entry. The resulting payload is stored in Angel Memory 402 with metadata including timestamp, originating device, content type, and applicable policy restrictions.

Because each device 610a-610c is associated with the same authenticated user account, the server 602 ensures that Angel Memory 402 is synchronized in near real time across all endpoints. For example, a code snippet copied on the mobile device 610a and stored as entry 404 becomes immediately available for paste operations on the desktop device 610b or the tablet 610c. Similarly, a secured copy designated as entry 416 requires authentication before decryption and retrieval on any endpoint. The notification service 136 propagates availability signals to each client, while the availability detectors (e.g., 172) monitor local application context to determine whether retrieval is appropriate. This architecture provides a unified, account-based memory layer that extends clipboard operations seamlessly across mobile, desktop, and tablet platforms while enforcing centralized governance, encryption, and synchronization policies.

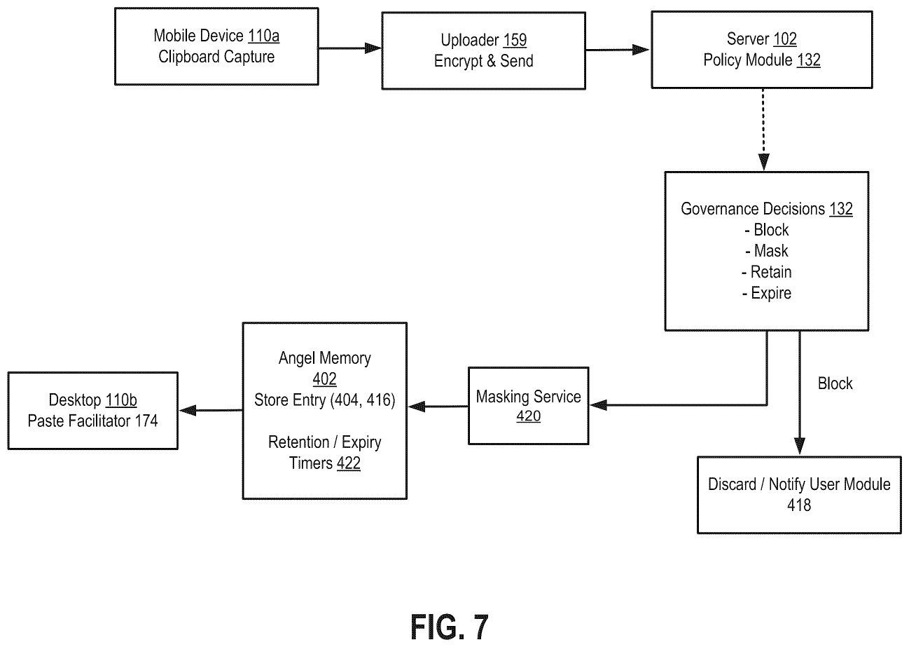

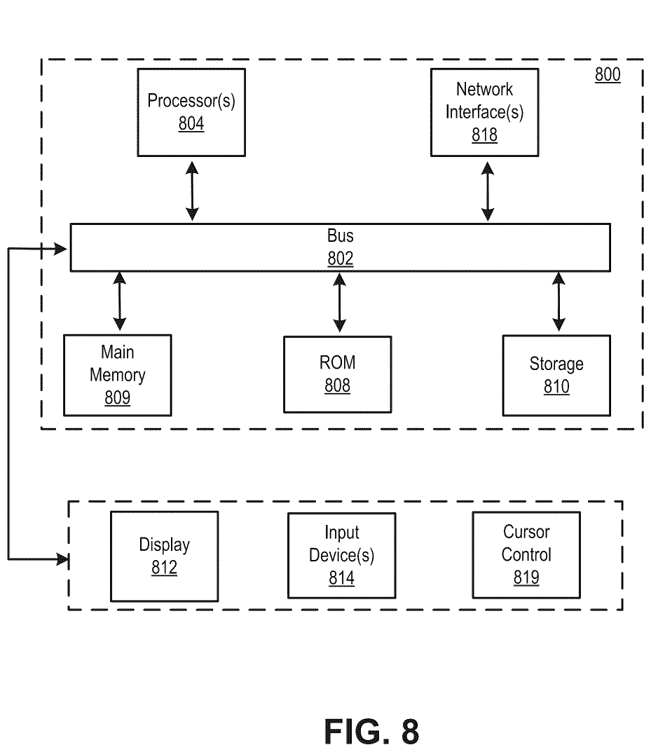

FIG. 7 is a block diagram illustrating enforcement of policy and governance during cross-device clipboard synchronization. A copy event detected on the mobile device 110a (clipboard capture) is provided to an uploader 159, which encrypts the payload and transmits it to the server 102. At the server, a policy module 132 evaluates the payload and issues governance decisions 132, including block, mask, retain, or expire. For mask decisions, the payload is routed to a masking service 420, which obfuscates designated substrings prior to storage. For block decisions, the payload is diverted to a discard/notify user module 418, which prevents storage and optionally emits a client-visible notice. When permitted, the processed payload is stored in Angel Memory 402 as either a transfer entry 404 or a secured entry 416, with retention/expiry timers 422 applied per policy. The desktop device 110b, via paste facilitator 174, subsequently retrieves permitted entries from Angel Memory 402 for decryption and insertion as described elsewhere. This governance pipeline ensures centrally administered controls are applied before any cross-device recall, while providing auditable outcomes for block, mask, and retention actions.

Where components, logical circuits, or engines of the technology are implemented in whole or in part using software, in one embodiment, these software elements can be implemented to operate with a computing or logical circuit capable of carrying out the functionality described with respect thereto. One such example computing module is shown in FIG. 8. Various embodiments are described in terms of this example computing module 800. After reading this description, it will become apparent to a person skilled in the relevant art how to implement the technology using other logical circuits or architectures.

FIG. 8 illustrates an example computing module 800, an example of which may be a processor/controller resident on a mobile device, or a processor/controller used to operate a payment transaction device, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIGS. 1A-1E. Various embodiments are described in terms of this example-computing module 800. After reading this description, it will become apparent to a person skilled in the relevant art how to implement the application using other computing modules or architectures.

Referring now to FIG. 8, computing module 800 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 800 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 800 might include, for example, one or more processors, controllers, control modules, or other processing devices, such as a processor 804. Processor 804 might be implemented using a general-purpose or special-purpose processing engine such as, for example, a microprocessor, controller, or other control logic. In the illustrated example, processor 804 is connected to a bus 802, although any communication medium can be used to facilitate interaction with other components of computing module 800 or to communicate externally. The bus 802 may also be connected to other components such as a display 812, input devices 814, or cursor control 816 to help facilitate interaction and communications between the processor and/or other components of the computing module 800.

Computing module 800 might also include one or more memory modules, simply referred to herein as main memory 806. For example, preferably random-access memory (RAM) or other dynamic memory might be used for storing information and instructions to be executed by processor 804. Main memory 806 might also be used for storing temporary variables or other intermediate information during execution of instructions to be executed by processor 804. Computing module 800 might likewise include a read only memory (“ROM”) 808 or other static storage device 810 coupled to bus 802 for storing static information and instructions for processor 804.

Computing module 800 might also include one or more various forms of information storage devices 810, which might include, for example, a media drive and a storage unit interface. The media drive might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to or accessed by media drive. As these examples illustrate, the storage media can include a computer usable storage medium having stored therein computer software or data.

In alternative embodiments, information storage devices 810 might include other similar instrumentalities for allowing computer programs or other instructions or data to be loaded into computing module 800. Such instrumentalities might include, for example, a fixed or removable storage unit and a storage unit interface. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 800.

Computing module 800 might also include a communications interface or network interface(s) 818. Communications or network interface(s) interface 818 might be used to allow software and data to be transferred between computing module 800 and external devices. Examples of communications interface or network interface(s) 818 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications or network interface(s) 818 might typically be carried on signals, which can be electronic, electromagnetic (which includes optical) or other signals capable of being exchanged by a given communications interface. These signals might be provided to communications interface 818 via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 806, ROM 808, and storage unit interface 810. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 800 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method for cross-device clipboard synchronization, comprising:
detecting, at a first client device, a copy event corresponding to content selected by a user;
encrypting the copied content and transmitting the encrypted content to a conversational application server;
classifying the copied content at the server to determine a content type;
storing the copied content as an entry in a user-scoped memory maintained by the server;
transmitting a notification to a second client device indicating availability of the entry;
receiving, at the server, a paste request initiated from the second client device; and
retrieving and decrypting the entry for insertion into an active input field of the second client device.

2. The method of claim 1, wherein the user-scoped memory comprises Angel Memory, and wherein multiple entries are persisted with associated metadata including a timestamp, originating device, and content type.

3. The method of claim 1, wherein classifying the copied content comprises detecting that the copied content is a code snippet, and further comprises preserving formatting elements including indentation, whitespace, and encoding during storage and retrieval.

4. The method of claim 3, wherein classifying the copied content comprises detecting that the copied content is a one-time passcode (OTP), and further comprises enforcing an expiration window and single-use policy prior to storage and retrieval.

5. The method of claim 1, further comprising: receiving, at the first client device, a user selection of a secured copy option; storing the copied content as a secured entry requiring authentication; and, prior to retrieval at the second client device, requiring entry of a password or biometric credential before decrypting and releasing the secured entry.

6. The method of claim 1, further comprising enforcing one or more governance decisions including block, mask, retain, or expire, applied by a policy module prior to storage of the copied content.

7. The method of claim 6, wherein the first and second client devices are selected from a group consisting of a mobile device, a desktop computer, and a tablet computer, and wherein the copied content is synchronized across all authenticated user devices.

8. A computer-implemented system for cross-device clipboard synchronization, comprising:
a first client device including a clipboard capture agent configured to detect a copy event and an uploader configured to encrypt and transmit copied content;
a conversational application server comprising:
a content classification engine configured to determine a content type of the copied content;
a user-scoped memory configured to store the copied content as entries associated with a user account; and
a notification service configured to signal availability of the entries to one or more additional client devices; and
a second client device comprising:
an availability detector configured to determine that an application context is suitable for paste;
a paste facilitator configured to request retrieval of an entry; and
a decryption module configured to decrypt and insert the entry into an active input field.

9. The system of claim 8, wherein the user-scoped memory comprises Angel Memory configured to persist multiple entries with associated metadata including a timestamp, originating device, and content type.

10. The system of claim 8, wherein the content classification engine is further configured to detect that the copied content is a code snippet, and wherein the server further comprises a code preservation module configured to preserve formatting elements including indentation, whitespace, and encoding during storage and retrieval.

11. The system of claim 8, wherein the content classification engine is further configured to detect that the copied content is a one-time passcode (OTP), and wherein the server further comprises an OTP handling module configured to enforce an expiration window and single-use policy prior to storage and retrieval.

12. The system of claim 8, further comprising a user interface on the first client device enabling selection of a secured copy option, wherein the uploader is further configured to transmit the copied content as a secured entry, and wherein the server is further configured to require entry of a password or biometric credential before releasing the secured entry to the second client device.

13. The system of claim 8, wherein the server further comprises a policy module configured to apply governance decisions including block, mask, retain, or expire prior to storage of the copied content in the user-scoped memory.

14. The system of claim 8, wherein the first and second client devices are selected from a group consisting of a mobile device, a desktop computer, and a tablet computer, and wherein the notification service is configured to propagate availability of the entries across all authenticated user devices.
